(19) United States
(12) Patent Application Publication
(10) Pub. No.: US 2014/0211017 A1
(43) Pub. Date: Jul. 31, 2014

(54) LINKING AN ELECTRONIC RECEIPT TO A CONSUMER IN A RETAIL STORE

(71) Applicant: WAL-MART STORES, INC., Bentonville, AR (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/756,203

(22) Filed: Jan. 31, 2013

(51) Int. Cl. H04N 7/18

(52) U.S. Cl. CPC H04N 7/18
USPC 348/150

(57) ABSTRACT

A computer-implemented method is disclosed herein. The method includes the step of receiving, at a processing device of a commerce server, a first video signal containing an image of a consumer's face. The method also includes the step of linking, with the processing device, a receipt of a purchase by the consumer of at least one product with the image of the consumer's face. The method also includes the step of receiving, at the processing device, a second video signal generated at an exit of a retail store. The method also includes the step of identifying, with the processing device, the consumer in the second video signal based on the image of the consumer's face in the first video signal. The method also includes the step of transmitting, with the processing device, a receipt signal containing the receipt to a display positioned at the exit of the retail store in response to the identifying step.

### BACKGROUND INFORMATION

1. Field of the Disclosure

The present invention relates generally to linking an electronic receipt to a consumer in a retail store. In particular, an image of the consumer's face can be linked to an electronic receipt for products purchased by the consumer. The electronic receipt can then be transmitted to a display for review by an employee of the retail store that is positioned proximate to an exit of the retail store. The electronic receipt can be transmitted to the display when the consumer's face is detected near the exit.

2. Background

Retail stores implement a variety of methods to deter shoplifting. One method of deterring product theft is to place an employee near an exit of the retail store to greet the consumer and check the products that the consumer has in his or her possession with items listed on a paper receipt. Typically, after the consumer has paid for the products, an employee at the checkout station hands the consumer a paper receipt. The consumer can be pushing a cart full of products and can have her hands full of other personal items such as hand bags or even a child or two, so the receipt is quickly stuffed in a coat pocket or handbag or the like so that the consumer can move away from the checkout station. When the consumer approaches the exit, the consumer is reminded that the employee needs to be handed the receipt so that it can be checked against the products in the consumer's possession. The consumer must then discard the personal items and dig around in her pockets or handbag to find the receipt that was just given to the consumer a short time earlier. The process of requiring a consumer to hand a paper receipt back to an employee of the store prior to exiting can be inconvenient and/or cause annoyance to the consumer. In addition, in some instances the customer is issued a digital receipt and may have opted out of paper and thus the burden of finding the digital receipt (in phone) is even higher.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 is an example schematic illustrating a system according to some embodiments of the present disclosure.

FIG. 2 is an example block diagram illustrating an augmented reality device unit that can be applied in some embodiments of the present disclosure.

FIG. 3 is an example block diagram illustration of a commerce server that can be applied in some embodiments of the present disclosure.

FIG. 4A is an exemplary view of checkout stations and an exit of a retail store in some embodiments of the present disclosure.

FIG. 4B is an exemplary field of view perceived by an employee positioned at an exit at a retail store.

FIG. 5 is an example flow chart illustrating a method that can be carried out according to some embodiments of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present disclosure. It will be apparent, however, to one having ordinary skill in the art that the specific detail need not be employed to practice the present disclosure. In other instances, well-known materials or methods have not been described in detail in order to avoid obscuring the present disclosure.

Reference throughout this specification to “one embodiment”, “an embodiment”, “one example” or “an example” means that a particular feature, structure or characteristic described in connection with the embodiment or example is included in at least one embodiment of the present disclosure. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present disclosure may take the form of a computer program product embodied in any tangible medium of expression having computer-usable program code embodied in the medium.

Embodiments of the present disclosure can be implemented by a retail store to deter product theft. Some retail stores utilize an employee positioned near an exit for checking products in the possession of consumers. A paper receipt listing the products purchased can be compared to the products possessed. This method of theft prevention has its drawbacks as it can generally be an annoyance to the consumer.

Retail stores have an incentive to make the shopping experience more efficient and convenient for the consumer so that they will enjoy the experience and want to shop again at that retail store. Improving efficiency and convenience can be a valuable tool for marketing and drawing additional consumers into the retail store. One method of improving the shopping experience of the consumer is to minimize the inconvenience that the consumer has with store employees checking goods in their shopping cart against a paper receipt or asking the consumer to produce their digital receipt if applicable.

It is contemplated by the present disclosure that an electronic receipt can be linked to a consumer and transmitted to a display such that an employee can check products in the possession of the consumer against the listing of products on the receipt, shown on the display, without inconveniencing the consumer by requiring him or her to produce a paper receipt.

In some embodiments of the present disclosure, a commerce server can receive a first video signal that contains an image or images (frames) of the face of the consumer. The first video signal can be generated by a camera located proximate to a checkout station as the consumer is paying for products. An electronic checkout register located at a checkout station can generate an electronic receipt of the purchased products and transmit the electronic receipt to the commerce server. The commerce server can store both the receipt and the image of the consumer in a database. The commerce server can also electronically link the receipt and the image of the consumer's face in the database.

A second video signal generated by a camera near an exit of the retail store can contain images of consumers as they approach the exit. The commerce server can analyze the second video signal and identify a consumer in the second video signal based on the image of the consumer's face contained in the first video signal. When the consumer is identified, the commerce server can transmit the receipt that was previously linked to the consumer to a display positioned near an exit of the retail store. An employee can review the list of products on the display relative to the products in a cart or otherwise in the possession of the consumer.

In some embodiments of the present disclosure, the video signals can be taken by stand-alone cameras and electronic information can be transmitted to one or more stand-alone displays near the exit of the retail store. In other embodiments of the present disclosure, a first augmented reality device can be worn by an employee at the checkout station and a second augmented reality device can be worn by an employee proximate to the exit of the retail store. Each augmented reality device can have one or more cameras operable to generate and transmit video signals. Also, the augmented reality device at the exit of the retail store can include a display for receiving a receipt signal containing the receipt associated with the consumer.

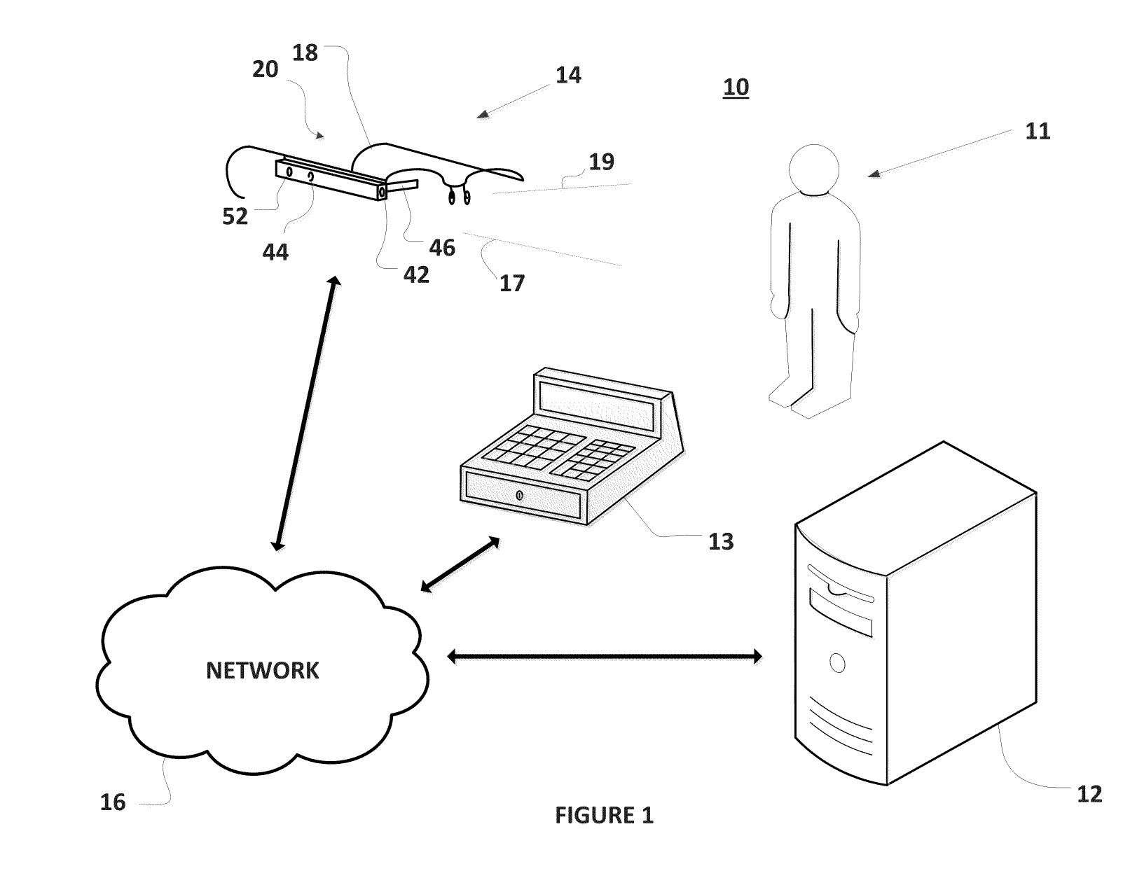

FIG. 1 is a schematic illustrating a theft deterrent system 10 for identifying a consumer and linking an electronic receipt to that consumer according to some embodiments of the present disclosure. The theft deterrent system 10 can execute a computer-implemented method that includes the step of receiving a first video signal containing an image of a consumer's face 11 at a commerce server 12. The first video signal can be transmitted from an augmented reality device such as head mountable unit 14.

The head mountable unit 14 can be worn by an employee operating a checkout station having a checkout register 13. The exemplary head mountable unit 14 includes a frame 18 and a communications unit 20 supported on the frame 18. The communications unit 20 of the head mountable unit 14 can include a microphone 44 and speakers 52 for audio communication and a display 46 for receiving and displaying electronic visual communication such as text, graphics and video signals.

The consumer's face 11 can be in the field of view of a camera 42 of the head mountable unit 14. The field of view of the camera 42 is illustrated schematically by dashed lines 17 and 19. It is noted that in some embodiments, a camera capturing an image of the consumer's face can be distinct from an augmented reality device.

Signals transmitted by the head mountable unit 14 and received by the commerce server 12 can be transmitted over a network 16. As used herein, the term “network” can include, but is not limited to, a Local Area Network (LAN), a Metropolitan Area Network (MAN), a Wide Area Network (WAN), the Internet, or combinations thereof. Embodiments of the present disclosure can be practiced with a wireless network, a hard-wired network, or any combination thereof.

The checkout register 13 can be configured to generate a receipt signal containing a receipt of a purchase by the consumer. The receipt signal can be transmitted to the commerce server 12 over the network 16. The commerce server 12 can include a database. The commerce sever 12 can store the receipt and the image of the consumer's face 11 in the database. The receipt and the image of the consumer's face 11 can be correlated together in the database.

A second video signal can be generated at an exit of the retail store. The second video signal can be generated from a second head mountable unit similar to the head mountable unit 14. The second video signal can be continuously generated and monitored by the commerce server 12. The second head mountable unit can be worn by an employee positioned at an exit of the retail store. The consumer's face 11 can come into the field of view of a camera of the second head mountable unit when the consumer approaches the exit of the retail store.

The commerce server 12 can be continuously receiving and monitoring the second video signal. The commerce server 12 can detect faces in the second video signal and compare detected faces with the images of faces stored in the database. When the commerce server 12 identifies a match between a face contained in the second video signal and an image of a face in the database, the commerce server 12 can transmit the receipt associated with the face to a display positioned at the exit of the retail store. The display can be a display associated with an augmented reality worn by an employee positioned at an exit of the retail store. The employee can view the receipt on the display and then inspect the products possessed by the consumer without requiring the consumer to present a paper receipt. The image of the consumer's face might also be sent to the employee at the exit so he can confirm the person encountered is actually that consumer associated with the receipt.

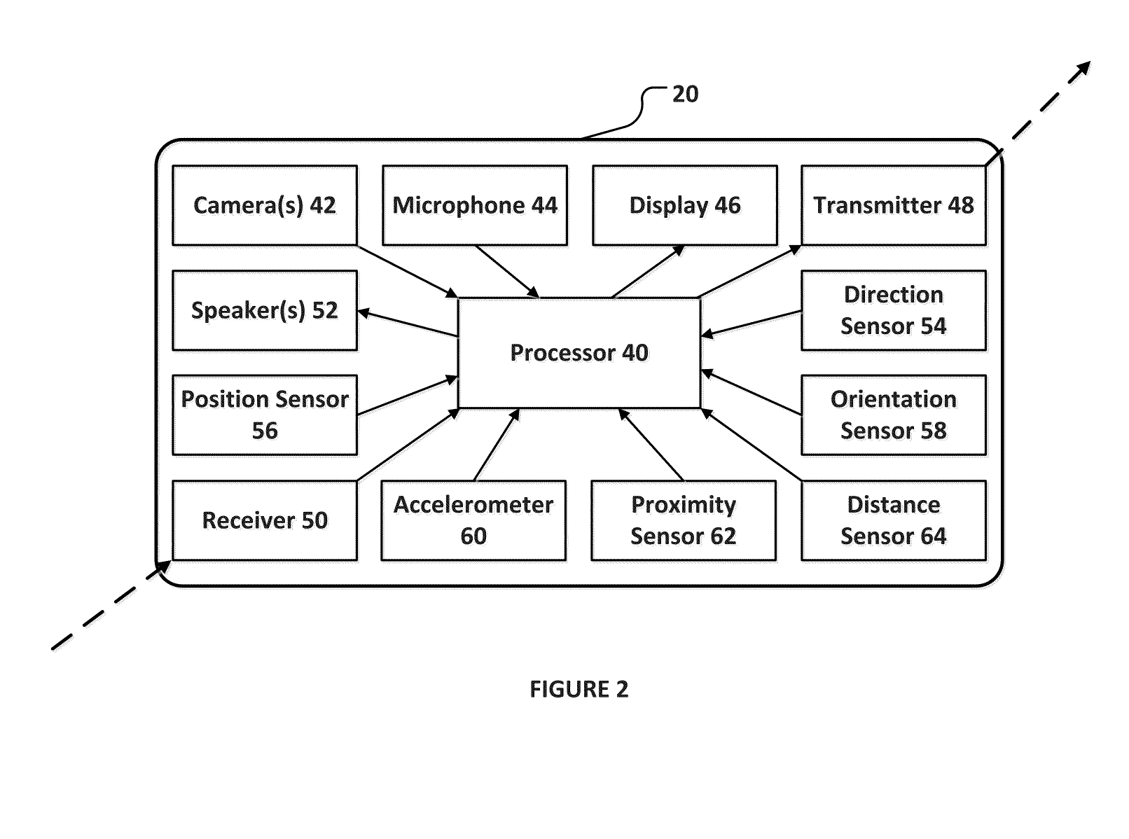

FIG. 2 is a block diagram illustrating exemplary components of the communications unit 20. The communications unit can include a processor 40, one or more cameras 42, a microphone 44, a display 46, a transmitter 48, a receiver 50, one or more speakers 52, a direction sensor 54, a position sensor 56, an orientation sensor 58, an accelerometer 60, a proximity sensor 62, and a distance sensor 64.

The processor 40 can be operable to receive signals generated by the other components of the communications unit 20. The processor 40 can also be operable to control the other components of the communications unit 20. The processor 40 can also be operable to process signals received by the head mount unit 14. While one processor 40 is illustrated, it should be appreciated that the term “processor” can include two or more processors that operate in an individual or distributed manner.

The head mountable unit 14 can include one or more cameras 42. Each camera 42 can be configured to generate a video signal. One of the cameras 42 can be oriented to generate a video signal that approximates the field of view of the person, such as consumer or a retail store employee, whom is wearing the head mountable unit 14. Each camera 42 can be operable to capture single images and/or video and to generate a video signal based thereon. The video signal may be representative of the field of view of the person wearing the head mountable unit 14.

In some embodiments of the disclosure, cameras 42 may be a plurality of forward-facing cameras 42. The cameras 42 can be a stereo camera with two or more lenses with a separate image sensor or film frame for each lens. This arrangement allows the camera 42 to simulate human binocular vision and thus capture three-dimensional images. This process is known as stereo photography. The cameras 42 can be configured to execute computer stereo vision in which three-dimensional information is extracted from digital images. In such embodiments, the orientation of the cameras 42 can be known and the respective video signals can be processed to triangulate an object with both video signals. This processing can be applied to determine the distance that the person is spaced from the object. Determining the distance that the person is spaced from the object can be executed by the processor 40 or by the commerce server 12 using known distance calculation techniques.

Processing of the one or more, forward-facing video signals can also be applied to determine the identity of the object. Determining the identity of the object, such as the identity of a product or a consumer in the retail store, can be executed by the processor 40 or by the commerce server 12. If the processing is executed by the commerce server 12, the processor 40 can modify the video signals limit the transmission of data back to the commerce server 12. For example, the video signal can be parsed and one or more image files can be transmitted to the commerce server 12 instead of a live video feed. Further, the video can be modified from color to black and white to further reduce transmission load and/or ease the burden of processing for either the processor 40 or the commerce server 12. Also, the video can be cropped to an area of interest to reduce the transmission of data to the commerce server 12.

In some embodiments of the present disclosure, the cameras 42 can include one or more inwardly-facing camera 42 directed toward the eyes of the person wearing the augmented reality device 14. A video signal revealing the eyes can be processed using eye tracking techniques to determine the direction that the person is viewing. In one example, a video signal from an inwardly-facing camera can be correlated with one or more forward-facing video signals to determine the object the person is viewing.

The microphone 44 can be configured to generate an audio signal that corresponds to sound generated by and/or proximate to the person. The audio signal can be processed by the processor 40 or by the commerce server 12. For example, verbal signals can be processed by the commerce server 12 such as “this is the next consumer at the checkout station.” Such audio signals can be correlated to the video recording.

The display 46 can be positioned within the person's field of view. Video content can be shown to the person with the display 46. The display 46 can be configured to display text, graphics, images, illustrations and any other video signals to the person. The display 46 can be transparent when not in use and partially transparent when in use to minimize the obstruction of the person's field of view through the display 46.

The transmitter 48 can be configured to transmit signals generated by the other components of the communications unit 20 from the head mountable unit 14. The processor 40 can direct signals generated by components of the communications unit 20 to the commerce sever 12 through the transmitter 48. The transmitter 48 can be an electrical communication element within the processor 40. In one example, the processor 40 is operable to direct the video and audio signals to the transmitter 40 and the transmitter 48 is operable to transmit the video signal and/or audio signal from the head mountable unit 14, such as to the commerce server 12 through the network 16.

The receiver 50 can be configured to receive signals and direct signals that are received to the processor 40 for further processing. The receiver 50 can be operable to receive transmissions from the network 16 and then communicate the transmissions to the processor 40. The receiver 50 can be an electrical communication element within the processor 40. In some embodiments of the present disclosure, the receiver 50 and the transmitter 48 can be an integral unit.

The transmitter 48 and receiver 50 can communicate over a Wi-Fi network, allowing the head mountable device 14 to exchange data wirelessly (using radio waves) over a computer network, including high-speed Internet connections. The transmitter 48 and receiver 50 can also apply Bluetooth® standards for exchanging data over short distances by using short-wavelength radio transmissions, and thus creating personal area network (PAN). The transmitter 48 and receiver 50 can also apply 3G or 4G, which is defined by the International Mobile Telecommunications-2000 (IMT-2000) specifications promulgated by the International Telecommunication Union.

The head mountable unit 14 can include one or more speakers 52. Each speaker 52 can be configured to emit sounds, messages, information, and any other audio signal to the person. The speaker 52 can be positioned within a range of hearing of the person wearing the head mountable unit 14. Audio content transmitted by the commerce server 12 can be played for the person through the speaker 52. The receiver 50 can receive the audio signal from the commerce server 12 and direct the audio signal to the processor 40. The processor 40 can then control the speaker 52 to emit the audio content.

The direction sensor 54 can be configured to generate a direction signal that is indicative of the direction that the person is facing. The direction signal can be processed by the processor 40 or by the commerce server 12. For example, the direction sensor 54 can electrically communicate the direction signal containing direction data to the processor 40 and the processor 40 can control the transmitter 48 to transmit the direction signal to the commerce server 12 through the network 16. By way of example and not limitation, the direction signal can be useful in determining the identity of a product(s) or persons visible in the video signal, as well as the location of the person within the retail store.

The direction sensor 54 can include a compass or another structure for deriving direction data. For example, the direction sensor 54 can include one or more Hall effect sensors. A Hall effect sensor is a transducer that varies its output voltage in response to a magnetic field. For example, the sensor operates as an analog transducer, directly returning a voltage. With a known magnetic field, its distance from the Hall plate can be determined. Using a group of sensors disposing about a periphery of a rotatable magnetic needle, the relative position of one end of the needle about the periphery can be deduced. It is noted that Hall effect sensors can be applied in other sensors of the head mountable unit 14.

The position sensor 56 can be configured to generate a position signal indicative of the position of the person within the retail store. The position sensor 56 can be configured to detect an absolute or relative position of the person wearing the head mountable unit 14. The position sensor 56 can electrically communicate a position signal containing position data to the processor 40 and the processor 40 can control the transmitter 48 to transmit the position signal to the commerce server 12 through the network 16.

Identifying the position of the person can be accomplished by radio, ultrasound or ultrasonic, infrared, or any combination thereof. The position sensor 56 can be a component of a real-time locating system (RTLS), which is used to identify the location of objects and people in real time within a building such as a retail store. The position sensor 56 can include a tag that communicates with fixed reference points in the retail store. The fixed reference points can receive wireless signals from the position sensor 56. The position signal can be processed to assist in determining one or more products that are proximate to the person and are visible in the video signal.

The orientation sensor 58 can be configured to generate an orientation signal indicative of the orientation of the person's head, such as the extent to which the person is looking downward, upward, or parallel to the ground. A gyroscope can be a component of the orientation sensor 58. The orientation sensor 58 can generate the orientation signal in response to the orientation that is detected and communicate the orientation signal to the processor 40. The orientation of the person's head can indicate whether the person is viewing a lower shelf, an upper shelf, or a middle shelf.

The accelerometer 60 can be configured to generate an acceleration signal indicative of the motion of the person. The acceleration signal can be processed to assist in determining if the person has slowed or stopped, tending to indicate that the person is evaluating one or more products for purchase. The accelerometer 60 can be a sensor that is operable to detect the motion of the person wearing the head mountable unit 14. The accelerometer 60 can generate a signal based on the movement that is detected and communicate the signal to the processor 40. The motion that is detected can be the acceleration of the person and the processor 40 can derive the velocity of the person from the acceleration. Alternatively, the commerce server 12 can process the acceleration signal to derive the velocity and acceleration of the person in the retail store.

The proximity sensor 62 can be operable to detect the presence of nearby objects without any physical contact. The proximity sensor 62 can apply an electromagnetic field or a beam of electromagnetic radiation such infrared and assess changes in the field or in the return signal. Alternatively, the proximity sensor 62 can apply capacitive photoelectric principles or induction. The proximity sensor 62 can generate a proximity signal and communicate the proximity signal to the processor 40. The proximity sensor 62 can be useful in determining when a person has grasped and is inspecting a product.

The distance sensor 64 can be operable to detect a distance between an object and the head mountable unit 14. The distance sensor 64 can generate a distance signal and communicate the signal to the processor 40. The distance sensor 64 can apply a laser to determine distance. The direction of the laser can be aligned with the direction that the person is facing. The distance signal can be useful in determining the distance to an object in the video signal generated by one of the cameras 42, which can be useful in determining the person's location in the retail store. The distance sensor 64 can operate as a laser based system as known to those skilled in the art.

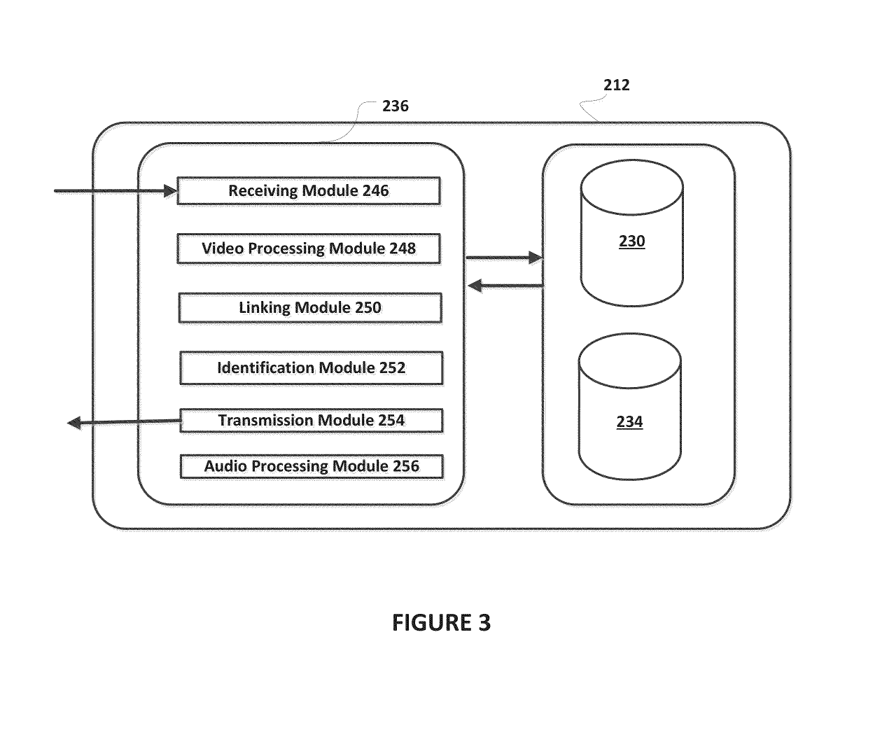

FIG. 3 is a block diagram illustrating a commerce server 212 according to some embodiments of the present disclosure. In the illustrated embodiment, the commerce server 212 can include an image database 230 and a consumer receipt database 234. The commerce server 212 can also include a processing device 236 configured to include a receiving module 246, a video processing module 248, a linking module 250, an identification module 252, a transmission module 254 and an audio processing module 256.

Any combination of one or more computer-usable or computer-readable media may be utilized in various embodiments of the disclosure. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages.

The image database 230 can include in memory the images of the faces of consumers who have purchased products in the retail store. Facial recognition techniques, software, and systems as are known to those skilled in the art can be utilized by the commerce server 212 to identify, categorize and store the facial images in the image database 230 for later retrieval. The data in the image database 230 can be organized based on one or more tables that may utilize one or more algorithms and/or indexes.

The consumer receipt database 234 can include in memory electronic receipts for products that consumers have purchased in the retail store. Electronic receipts can be generated at a checkout station by a checkout register 13 and transmitted to the processing device 236 of the commerce server 212. Electronic receipts stored in the consumer receipt database 234 can be linked to a particular face of a consumer for later retrieval as desired, as will be described in more detail below. The data in the consumer receipt database 234 can be organized based on one or more tables that may utilize one or more algorithms and/or indexes.

The processing device 236 can communicate with the databases 230, 234 and receive one or more signals from the augmented reality device 14. The processing device 236 can include computer readable memory storing computer readable instructions and one or more processors executing the computer readable instructions.

The receiving module 246 can be operable to receive a first video signal containing an image of the consumer's face. The first video signal can be transmitted to the receiving module 246 of the processing device 236 by a camera 42 positioned proximate to a checkout station in the retail store. In one embodiment the camera 42 is associated with an augmented reality device 14 that can be worn by an employee located at the checkout station such as a cashier. In another embodiment the camera 42 can be positioned as a standalone device at the checkout station. The image of the consumer's face from the first video signal can processed using known facial recognition techniques and be stored in the image database 230.

The receiving module 246 can also receive a receipt signal that is linked to the image of the face of the consumer. The receipt signal can be transmitted from the checkout station to the receiving module 246 of the processing device 236. The checkout station can be configured to transmit receipt signals over the network 16. Each receipt signal contains data associated with a receipt of the purchase of products by a consumer. The signals of the images and the corresponding receipts can be linked together by linking module 250 of the processing device 236.

The linking module 250 of the processing device 236 is operable to link the consumer's facial image stored in the image database 230 to the consumer's receipt stored in the receipt database 234. The linking module 250 cooperates with other modules such as the video processing module 248 of the processing device 236 to create an electronic link between the image of the consumer's face in the image database 230 and the receipt in the consumer receipt database 234. The linked electronic receipt can then be called up from the consumer receipt database 234 when the processing device 236 receives a second video signal containing an image of the face of the consumer.

A linking signal is transmitted to the linking module 250 of the processing device 236 when a consumer purchases products at a checkout station. In one example the linking signal can be an audio signal transmitted by the first employee at the checkout station. The audio linking signal can be by way of example “Hello, I am glad to check you out today.” An audio processing module 256 can receive the audio linking signal from the processing device 236 to analyze and confirm the audio signal.

The audio processing module 256 can analyze the audio data contained in a consumer signal, such as verbal statements made by a consumer. The audio processing module 256 can implement known speech recognition techniques to identify speech in an audio signal. The consumer's speech can be encoded into a compact digital form that preserves its information. The encoding can occur at the head mountable unit 14 or at the commerce server 212. The audio processing module 256 can be loaded with a series of models honed to comprehend language. When encoded locally, the speech can be evaluated locally, on the head mountable unit 14. A recognizer installed on the head mountable unit 14 can communicate with the commerce server 212 to gauge whether the voice contains a command can be best handled locally or if the commerce server is better suited to execute the command. The audio processing module 256 can compare the consumer's speech against a statistical model to estimate, based on the sounds spoken and the order in which the sounds were spoken, what letters might be contained in the speech. At the same time, the local recognizer can compare the speech to an abridged version of that statistical model applied by the audio processing module 256. For both the commerce server 212 and the head mountable unit 14, the highest-probability estimates are accepted as the letters contained in the consumer's speech. Based on these estimations, the consumer's speech, now embodied as a series of vowels and consonants, is then run through a language model, which estimates the words of the speech. Given a sufficient level of confidence, the audio processing module 256 can then create a candidate list of interpretations for what the sequence of words in your speech might mean. If there is enough confidence in this result, the audio processing module 256 can determine the consumer's intent.

When the audio processing module 256 confirms the linking signal has been received, the linking module 250 of the processing device 236 can instruct the receiving module 246 to direct all video signals to the linking module 250 and also to direct that the next receipt signal to the linking module 250. The linking module 250 receives image signals and receipt signals and stores the signals such that the signals are cross-referenced to one another in memory locations in each of the databases 230, 234.

In another embodiment, the linking signal can include data generated from a checkout station. For example, the data signal can be generated by typing a “receipt code” or pushing a “receipt key” on a checkout station to create a linking signal that is transmitted to the linking module 250. Similar to the operation of the audio linking signal described above, after receive the data linking signal, the linking module 250 of the processing device 236 can instruct the receiving module 246 to direct all video signals to the linking module 250 and to also direct the next receipt signal to the linking module 250.

In one example of operation, a first facial image can be stored when the checkout process starts, after the linking signal is received. The first facial image can be an image of the face of the consumer who is currently paying for products. The first facial image can be stored at a memory location in the image database 230. When the checkout is complete and the receipt signal is received, the linking module 250 can store the receipt and any data associated therewith in the receipt database 234. Data associated with the receipt can include a memory location of the image of the first consumer's face in the image database 230. After the receipt is stored, the linking module 250 can again access the image database 230 and update the data associated with the image of the first consumer's face to include the memory location of that consumer's receipt in the receipt database 234.

The video processing module 248 can be operable to receive a second video signal from a camera 42, such as the camera 42 of an augmented reality device worn by an employee positioned near an exit of the retail store. The video processing module 248 can analyze the second video signal received from the augmented reality device 14 or from another camera. The video processing module 248 can implement known facial recognition/analysis techniques and algorithms to identify faces in the second video signal, such as the face of a consumer who has purchased products.

The video processing module 248 and linking module 250 are operable to function cooperatively with the identification module 252. For example, the identification module 252 can receive the analysis of the second video signal by the video processing module 248 and search the image database 230 for faces identified by the video processing module 248. Thus, when a consumer moves within the field of view of a second augmented reality device, the consumer's face can be recognized by the video processing module 248 and the identification module 252 can locate that consumer's face in the image database 230. The data associated with the consumer's face that is stored in the image database 230 can include the memory location of the consumer's receipt in the receipt database 234. The identification module 234 can then access the receipt database 234 and retrieve the consumer's receipt. The identification module 234 can then direct the transmission module 254 to transmit the consumer's receipt to the display 46 of the second augmented reality device.

After the receipt is transmitted to the display, the identification module 252 can then access the databases 230 and 234 and delete the data associated with the facial image and the data associated with the receipt from the image database 230 and receipt database 234, respectively. Images of the consumers and their corresponding receipts are temporarily stored in the system and then purged to make room for new consumers. This system minimizes complexity and operates relatively quickly because it is not building, manipulating or accessing a large database of consumers.

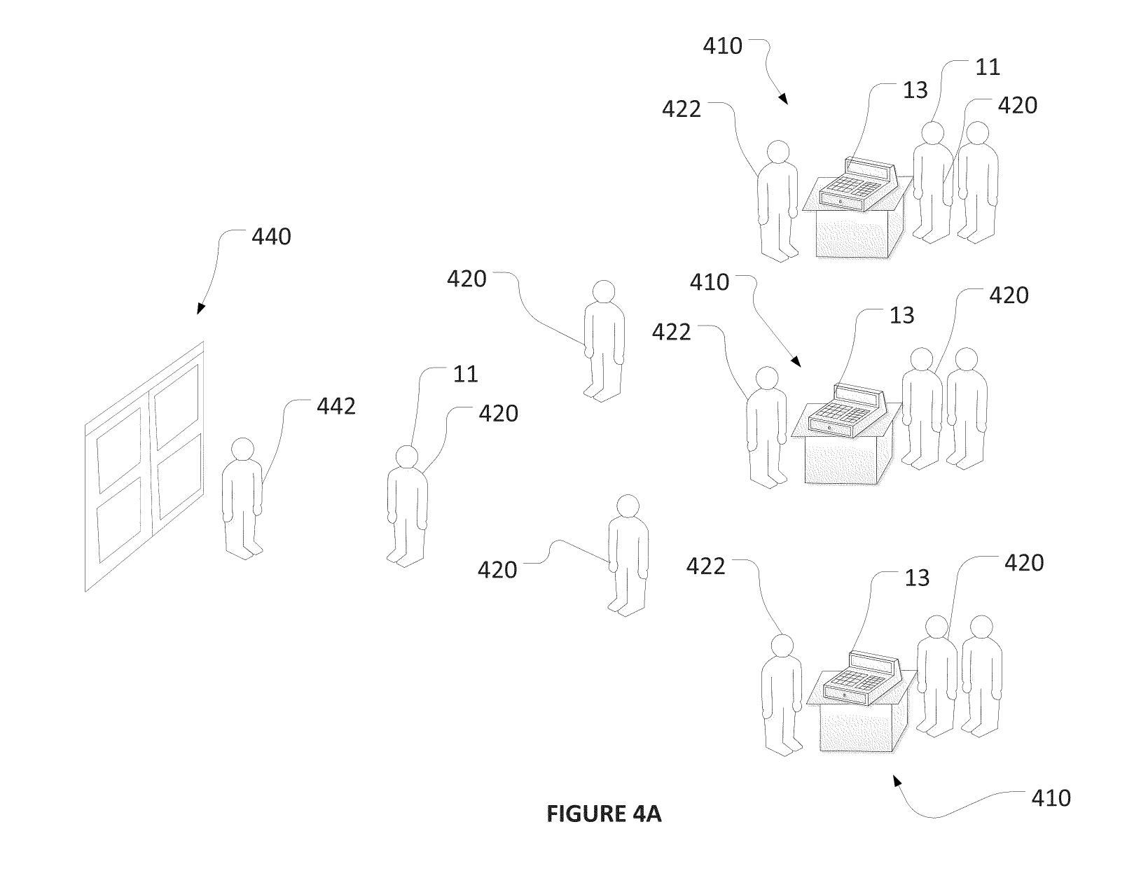

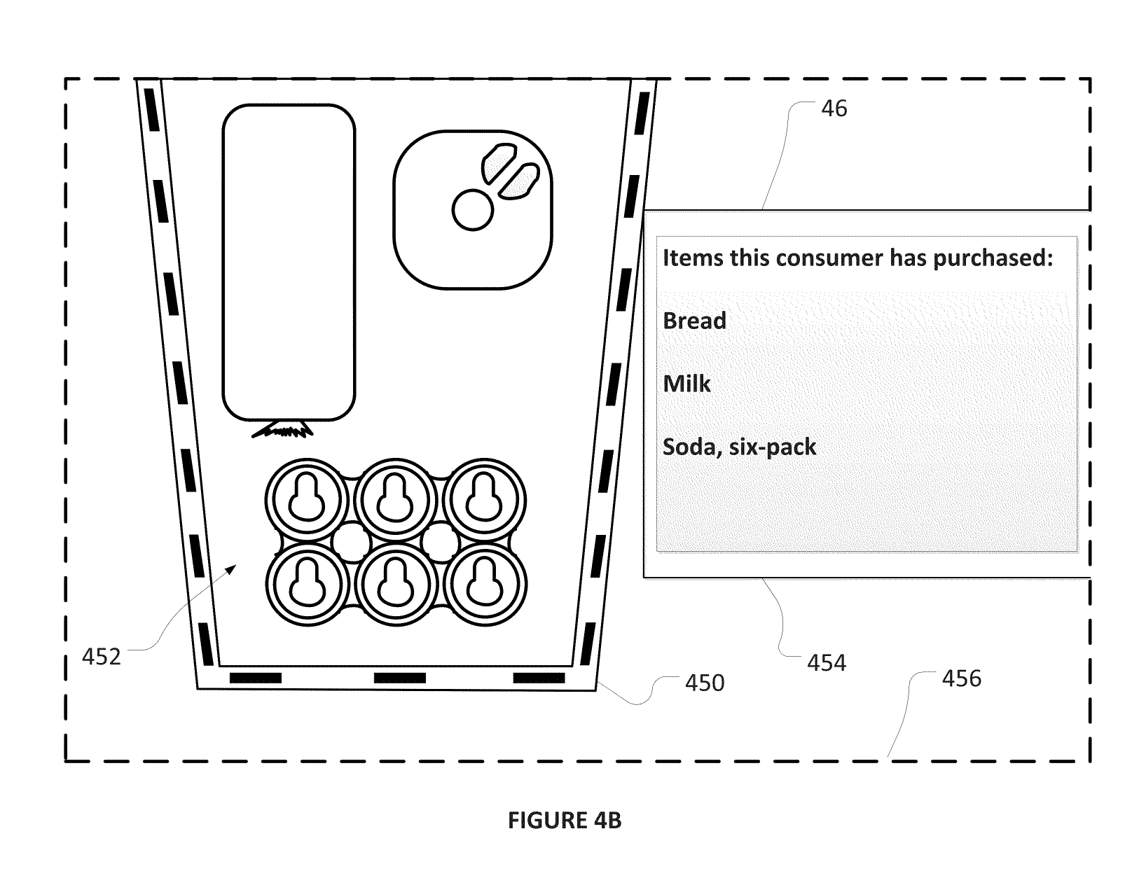

FIG. 4A depicts an exemplary view of a retail store having a plurality of checkout stations 410 for consumers 420 to pay for products prior to exiting the retail store. Each checkout station 410 can include a checkout register 13 operable to generate an electronic receipt for products purchased by the consumers 420. A first associate 422 can be positioned at the checkout station 410 to scan products into the checkout register 13. The first employee 422 can wear an augmented reality device as a head mountable unit 14 as described earlier. When a consumer 420 approaches the checkout station 410 and begins the process of paying for products, the first associate 422 can send a linking signal to the linking module 250 so that an image of the consumer's face 11 is retrieved and stored. A first video signal can be taken of the face 11 of the consumer 420 with the camera 42 of the augmented reality device 14 (best seen in FIG. 1) and can be received by the video processing module 248 of the commerce server 212. The commerce server 212 can store the first video signal containing the image of the face 11 of the consumer in the image database 230 as described above. The electronic receipt associated with the purchased products is also received by the receiving module 246 of the commerce server 212, linked to the image of the face 11 of the consumer 420 and stored in the consumer receipt database 234 as also previously described.

As the consumer leaves the checkout station 410 and heads to an exit 440, a second employee 442 positioned proximate to the exit 440 can see the consumer 420 approaching. An augmented reality device worn by the second employee 442 can generate and transmit a second video signal that is monitored by the commerce server 212. When the consumer 420 moves with the field of view of the second employee 442, the consumer's face 11 can become detectable in the second video signal. When the face 11 of the consumer 420 is identified in second video signal and in the image database 230, the identification module 252 can retrieve the consumer's receipt and can transmit the receipt to a display that the second employee 442 can view. The display can be a stand-alone monitor placed near the exit or alternatively can be a display associated with an augmented reality device that the second employee 442 can wear as a head mountable unit 14 (best seen in FIG. 1). It is noted that in some embodiments, the identification module 252 can also transmit a facial image signal containing the image of the face 11 of the consumer 420 with the receipt signal to the display.

FIG. 4B depicts a view of a shopping cart 450 that the second employee 442 may see by looking down into the shopping cart 450. Products 452 that the consumer 420 possesses can be viewed by the second employee 442 and compared with the list of products on the receipt 454. The dashed outline 456 illustrates a field view of the second employee 442. A portion of the second employee's field of view is occupied by the display 46. The second employee 442 can see the shopping cart as a natural view and can simultaneously view the list of products on the receipt 454 with the display 46. The products 452 can be compared to the list of products on the receipt 454 by the second employee 442 to ensure that all of the products 452 were paid for without requiring a paper receipt from the consumer 420. In this manner, the products 452 and receipt 454 can be compared quickly and efficiently so that the consumer can exit the retail store without undue delay.

It is noted that the various processing functions set forth above can be executed differently than described above in order to enhance the efficiency of an embodiment of the present disclosure in a particular operating environment. The processor 40 can assume a greater role in processing some of the signals in some embodiments of the present disclosure. For example, in some embodiments, the processor 40 on the head mountable unit 14 could modify the video stream to require less bandwidth. The processor 40 could convert a video signal containing color to black and white in order to reduce the bandwidth required for transmitting the video signal. In some embodiments, the processor 40 could crop the video, or sample the video and display frames of interest. A frame of interest could be a frame that is significantly different from other frames, such as a generally low quality video having an occasional high quality frame. Thus, in some embodiments, the processor 40 could selectively extract video or data of interest from a video signal containing data of interest and other data. Further, the processor 40 could process audio signals received through the microphone 44, such signals corresponding to audible commands from the consumer.

To limit the extent of the facial recognition analysis and the processing burdens associated therewith, additional parameters can be added to the search process. For example, the search can be limited to a particular retail store among a chain of retail stores. Also, the search can be limited to facial images stored within a predetermined period of time, such as the last fifteen minutes for example. In addition, facial images that are matched with consumers can be eliminated from the field of search. Further, clothing color could be applied to supplement facial recognition. Clothes are unlikely to change from checkout to leaving the store, which may not be the case for normal facial recognition applications.

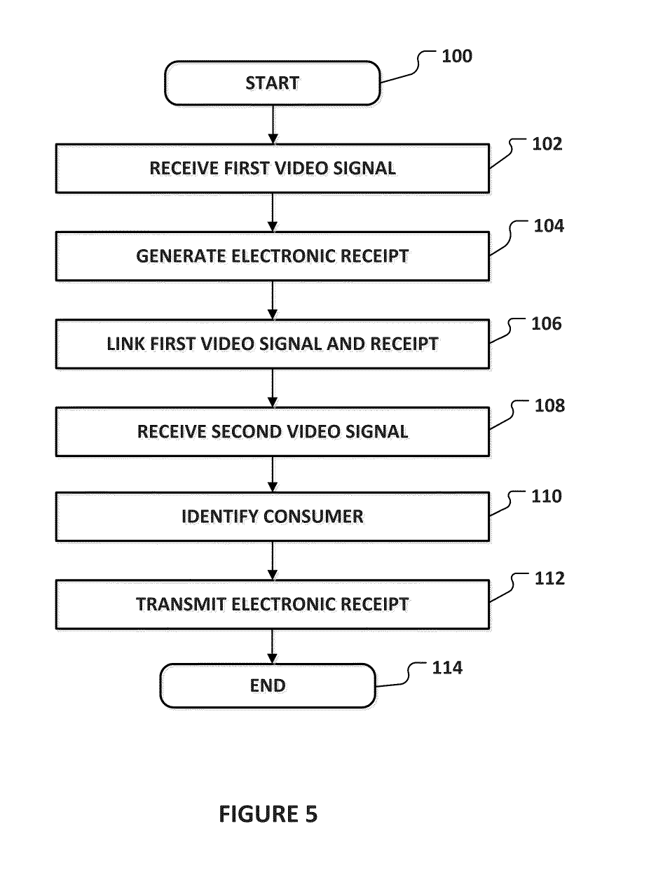

FIG. 5 is a flow chart illustrating a method that can be carried out in some embodiments of the present disclosure. The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

FIG. 5 illustrates a method can be executed by a commerce server. The commerce server can be located at the retail store or can be remote from the retail store. The method starts at step 100. At step 102, the commerce server can receive a first video signal containing an image of the face of a consumer who is purchasing products at a retail store. At step 104, an electronic receipt for products purchased at the retail store is generated at a checkout register and received the commerce server. At step 106, the processing device links the electronic product receipt to the first video signal containing the image of the face of the consumer. At step 108, the commerce server can receive a second video image of the face of the consumer as the consumer approaches an exit of the retail store. At step 110, the commerce server can determine the identity of the consumer based on the first video image of the face of the consumer. At step 112, the commerce server can transmit an electronic product receipt that was linked to the identified consumer to a display positioned proximate the exit of the retail store. The exemplary method ends at step 114.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The above description of illustrated examples of the present disclosure, including what is described in the Abstract, are not intended to be exhaustive or to be limitation to the precise forms disclosed. While specific embodiments of, and examples for, the present disclosure are described herein for illustrative purposes, various equivalent modifications are possible without departing from the broader spirit and scope of the present disclosure. Indeed, it is appreciated that the specific example voltages, currents, frequencies, power range values, times, etc., are provided for explanation purposes and that other values may also be employed in other embodiments and examples in accordance with the teachings of the present disclosure.

What is claimed is:

1. A computer-implemented method comprising:
receiving, at a processing device of a commerce server, a first video signal containing an image of a consumer's face;
linking, with the processing device, a receipt of a purchase by the consumer of at least one product with the image of the consumer's face;
receiving, at the processing device, a second video signal generated at an exit of a retail store;
identifying, with the processing device, the consumer in the second video signal based on the image of the consumer's face in the first video signal; and
transmitting, with the processing device, a receipt signal containing the receipt to a display positioned at the exit of the retail store in response to said identifying step to compare products possessed by the consumer with products listed on the receipt.

2. The computer-implemented method of claim 1 wherein the step of receiving the first video signal further comprises:
receiving the first video signal from a first camera associated with a first augmented reality device.

3. The computer-implemented method of claim 2 wherein the first augmented reality device is worn by a first employee of the retail store at a checkout station of the retail store spaced from the exit.

4. The computer-implemented method of claim 1 wherein the step of receiving the second video signal further comprises:
receiving the second video signal from a second camera associated with a second augmented reality device.

5. The computer-implemented method of claim 4 wherein the second augmented reality device is worn by a second employee of the retail store positioned proximate to the exit of the retail store.

6. The computer-implemented method of claim 4 wherein the step of transmitting the receipt signal further comprises:
transmitting the receipt signal to a display associated with the second augmented reality device.

7. The computer-implemented method of claim 1 further comprising:
storing the video signal containing the image of the face of the consumer in a database of the commerce server.

8. The computer-implemented method of claim 7 wherein the storing step is further defined as:
temporarily storing the video signal containing the image of the face of the consumer in a database of the commerce server.

9. The computer-implemented method of claim 1 wherein the step of identifying the consumer further comprises:
identifying, with the processing device, the consumer through facial recognition techniques.

10. The computer-implemented method of claim 1 wherein the step of transmitting the receipt signal further comprises:
transmitting, with the processing device, a facial image signal containing an image of the face of the consumer with the receipt signal to the display.

11. The computer-implemented method of claim 1 further comprising
comparing products in the possession of the consumer with the products listed on the receipt.

12. A theft deterrent system using a commerce server comprising a processing device having:
a receiving module configured to receive a first video signal containing an image of a consumer's face at a checkout station and a second video signal of the consumer's face generated at an exit of a retail store;
a linking module configured to link a receipt of a purchase by the consumer of at least one product with the image of the consumer's face;
a video processing module configured to identify the consumer in the second video signal based on the image of the consumer's face in the first video signal; and
a transmission module configured to transmit a receipt signal containing the receipt to a display positioned at the exit of the retail store.

13. The theft deterrent system of claim 12 wherein the first video signal is received from a first camera associated with a first augmented reality device worn by a first employee of the retail store positioned at a checkout register of the retail store.

14. The theft deterrent system of claim 12 wherein the second video is received from a second camera associated with a second augmented reality device worn by a second employee of the retail store positioned proximate to the exit.

15. The theft deterrent system of claim 14 wherein the receipt signal containing the receipt is transmitted to a display associated with the second augmented reality device.

16. A computer-implemented method comprising:
transmitting, with a first camera, a first video signal containing an image of a consumer's face to a processing device of a commerce server from a checkout station in a retail store;
receiving, at the processing device, a receipt signal containing a receipt of purchase by the consumer of at least one product from the checkout station;
linking, with the processing device, the receipt with the image of the consumer's face;
transmitting, to the processing device, a second video signal generated by a second camera positioned proximate to an exit of a retail store;
identifying, with the processing device, the consumer in the second video signal based on the image of the consumer's face contained in the first video signal; and
receiving at a display positioned proximate to the exit of the retail store, from the processing device, a receipt signal containing the receipt in response to the identifying step.

17. The computer-implemented method of claim 16 wherein the step of transmitting the first video signal further comprises:
transmitting the signal from a first camera associated with a first augmented reality device worn by a first employee of the retail store.

18. The computer-implemented method of claim 16 wherein the step of transmitting the second video signal further comprises:
transmitting the signal from a second camera associated with a second augmented reality device worn by a second employee of the retail store.

19. The computer-implemented method of claim 16 wherein said identifying step further comprises:
detecting, with the processing device, a plurality of different faces in the images of the second video signal; and
comparing, with the processing device, each of the plurality of different faces in the images of the second video signal with the image of the consumer's face contained in the first video signal.

20. The computer-implemented method of claim 16 further comprising:
storing the image of the consumer's face in a database of the commerce server in response to said step of receiving the receipt signal;
correlating, with the processing device, the receipt and the consumer's face in the database; and
purging the correlated receipt and the image of the consumer's face from the database after said receiving step.
